(19) United States
(12) Patent Application Publication
(10) Pub. No.: US 2009/0313660 A1
(43) Pub. Date: Dec. 17, 2009

(54) HOME ENTERTAINMENT SYSTEM AND OPERATING METHOD THEREOF

(75) Inventors: Tsang-Der Ni, Hsinchu (TW); Deng-Huei Hwang, Danshuei (TW); Ruey-Der Lou, Hsinchu (TW)

Correspondence Address: KIRTON AND MCCONKIE, 60 EAST SOUTH TEMPLE,, SUITE 1800, SALT LAKE CITY, UT, 84111, US

(73) Assignee: IMU SOLUTIONS, INC., Hsinchu (TW)

(21) Appl. No.: 12/485,256

(22) Filed: Jun. 16, 2009

(30) Foreign Application Priority Data
Jun. 16, 2008 (TW) 097122452

(51) Int. Cl. H04N 7/18; H04N 5/44

(52) U.S. Cl. 725/78; 348/734; 348/E05.103; 340/825.72

(57) ABSTRACT

A home entertainment system includes a first audio/video device and a remote controller. The first audio/video device has a wireless signal receiver. The remote controller includes a main body, a motion-sensing unit, a microprocessor, and wireless transmission unit. The main body is held by a user. The motion-sensing unit is disposed within the main body for generating a sensing signal in response to a motion of the main body by the user. The microprocessor is disposed within the main body and communicates with the motion-sensing unit for processing the sensing signal, thereby generating a control signal. The wireless transmission unit communicates with the microprocessor for receiving the control signal and wirelessly transmitting the control signal to the wireless signal receiver. A first selective item of an electronic menu shown on the first audio/video device is highlighted according to the control signal.

### FIELD OF THE INVENTION

The present invention relates to a home entertainment system, and more particularly to a home entertainment system including at least one audio/video device and a remote controller, in which a selective item of an electronic menu shown on the screen of the audio/video signal is highlighted according to a pitch motion, a yaw motion and a rolling motion of the remote controller.

### BACKGROUND OF THE INVENTION

Gramophones and radios are home entertainment devices in the early stage and are gradually replaced by TV sets. Conventionally, a TV set has a control panel with multiple keys or knobs. By operating the keys or knobs on the control panel, the user may power on/off the TV set, adjust the sound volume or choose a desired TV channel. Nowadays, the functions of the TV set are controlled by operating the keys of a remote controller. With the development of a videocassette recorder, a multimedia optical disc drive (e.g. DVD) player and recorder and a set-top box (STB), the functions of the TV set are expanded.

As the functions of the TV set are expanded, a remote controller with diverse keys has been developed. Due to the size restriction of the remote controller, only limited keys or buttons are arranged on the remote controller. For example, the common keys include a power-on key, several numeral keys, several directional keys, a confirmation key, a menu key, and so on. By operating the remote controller, an electronic menu or an on-screen display (abbreviated OSD) is shown on the screen of the TV set in order to display information such as volume, channel, and time.

FIG. 1 is a schematic functional block diagram illustrating a typical home entertainment system. As shown in FIG. 1, the home entertainment system 100 comprises a game device 101, an audio amplifier and loudspeaker 102, a network device 103, an audio/video receiving device 104, an audio/video displaying device 105, a sound receiving device 106 (e.g. a microphone), a video camera 107, an audio/video playing and recording device 108 (e.g. a CD or DVD player/recorder), a microprocessor 109, and a remote controller 110. These devices communicate with each other through a data bus 111.

FIG. 2 is a schematic functional block diagram illustrating another home entertainment system. As shown in FIG. 2, the home entertainment system comprises a game console 21, a computer 22, a TV set 24, a Hi-fi audio device 25 and an audio/video playing and recording device 26. Moreover, the TV set 24 communicates with a set-top box (STB) 23. Via the set-top box 23, various signals such as satellite signals, wired signals, wireless radio signals or network (e.g. ADSL) signals are received by the TV set 24 for being further processed. Alternatively, the signals or data could be set out via the set-top box 23.

Nowadays, the home entertainment system has more expanded functions and the selective items to be controlled are increased. Even if a remote controller cooperates with an electronic menu to control operations of the home entertainment system, the key arrangement of the remote controller is still complicated. Recently, as digital TV becomes more popular, the functions of a TV set and a personal computer are integrated into a single digital TV or a single personal computer. In addition to watching TV programs and execute many network functions such as data browsing and searching, network purchasing or network finance. For inputting data when the network functions are executed, the cooperation of the remote controller with an electronic menu is more feasible in comparison with the use of a keyboard or mouse in the TV set.

For most TV sets or electronic devices, a processor is used to control signal processing and image displaying tasks. When a specified key of the remote controller is depressed, multiple selective items are shown on the screen of the TV set or other electronic device. At this moment, the user could manipulate the up/down/left/right direction keys of the remote controller to highlight one of the selective items. After a confirmation key is depressed, a corresponding function is executed or a sub-menu is created.

The use of the remote controller, however, still has some drawbacks. For example, the user should alternately look at the selective items of the electronic menu shown on the screen and the operating keys on the remote controller in order to prevent erroneous operations. In some situations, the remote controller is held by one hand and the operating keys are clicked by the other hand in order to quickly control operations of the home entertainment system. In other words, the operations of the home entertainment system fail to be intuitively controlled. Moreover, when a direction key of the remote controller is depressed, the highlighted selective item is moved to its nearest neighboring selective item in the up/down/left/right direction. It is time-consuming and troublesome to depress the direction key for multiple times in order to move to the desired selective item.

Therefore, there is a need of providing a home entertainment system to obviate the drawbacks encountered from the prior art.

### SUMMARY OF THE INVENTION

The present invention relates to a home entertainment system including at least one audio/video device and a remote controller, in which a selective item of an electronic menu shown on the screen of the audio/video signal is highlighted according to a pitch motion, a yaw motion and a rolling motion of the remote controller.

In accordance with an aspect of the present invention, there is provided a home entertainment system. The home entertainment system includes a first audio/video device and a remote controller. The first audio/video device has a wireless signal receiver. The remote controller includes a main body, a motion-sensing unit, a microprocessor, and wireless transmission unit. The main body is held by a user. The motion-sensing unit is disposed within the main body for generating a sensing signal in response to a motion of the main body by the user. The microprocessor is disposed within the main body and communicates with the motion-sensing unit for processing the sensing signal, thereby generating a control signal. The wireless transmission unit communicates with the microprocessor for receiving the control signal and wirelessly transmitting the control signal to the wireless signal receiver. A first selective item of an electronic menu shown on the first audio/video device is highlighted according to the control signal.

In accordance with another aspect of the present invention, there is provided an operating method of a home entertainment system. The home entertainment system includes a first audio/video device and a remote controller. The operating method includes the following steps. Firstly, an electronic menu is shown on the first audio/video device. Then, the main body of the remote controller is held and a motion of the main body is created, so that a first selective item of the electronic menu is highlighted in response to the motion of the main body. Afterwards, the first audio/video device implements a function corresponding to the first selective item.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating a typical home entertainment system;

FIG. 2 is a schematic functional block diagram illustrating another home entertainment system;

FIG. 3A is a schematic diagram illustrating a home entertainment system according to an embodiment of the present invention;

FIG. 3B is a schematic perspective view illustrating the outward appearance of the remote controller used in the home entertainment system of the present invention;

FIG. 3C is a schematic functional block diagram illustrating the remote controller of FIG. 3B;

FIG. 4 is a schematic view illustrating an exemplary electronic menu shown on a screen of the TV set;

FIG. 5 is a schematic diagram illustrating the relationships between the pitch motions of the remote controller and the electronic menu;

FIG. 6 is a schematic diagram illustrating one-column right-side movement of the electronic menu according to the right yaw motion and the left rolling motion of the remote controller;

FIG. 7 is a schematic diagram illustrating one-column right-side according to the left yaw motion and the right rolling motion of the remote controller;

FIG. 8 is a schematic diagram illustrating the relationships between the yaw motions of the remote controller and the electronic menu; and

FIG. 9 is a flowchart schematically illustrating a method for operating the home entertainment system according to an embodiment of the present invention.

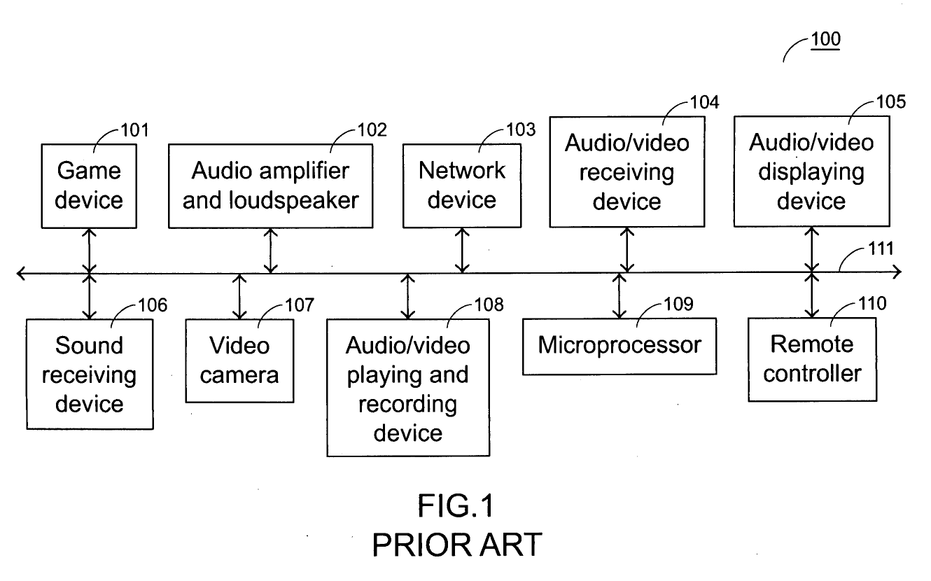

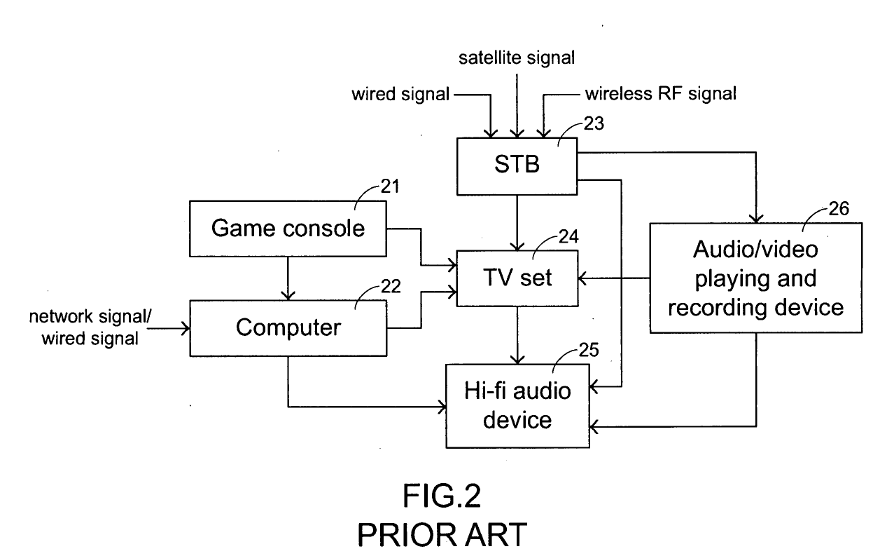

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides a novel remote controller having a motion-sensing unit to sense the hand's gesture. The power key, the sound volume key, and up/down channel switching key or the direction keys that are found in the conventional remote controller are exempted from the remote controller of the present invention. In cooperation with an electronic menu, the remote controller of the present invention is more user-friendly. For sensing the motion of the remote controller, the motion-sensing unit could include a combination of an electronic compass and an accelerometer, a combination of an electronic compass and a gyroscope, or an accelerometer and a gyroscope. The accelerometer produced by a Micro-electromechanical systems (MEMS) technology is preferred because it is relatively popular and cost-effective. The present invention will be illustrated by referring to the accelerometer as the motion-sensing unit. Nevertheless, an accelerometer, a gyroscope, an electronic compass, or a combination thereof is feasible for achieving the motion sensing purpose.

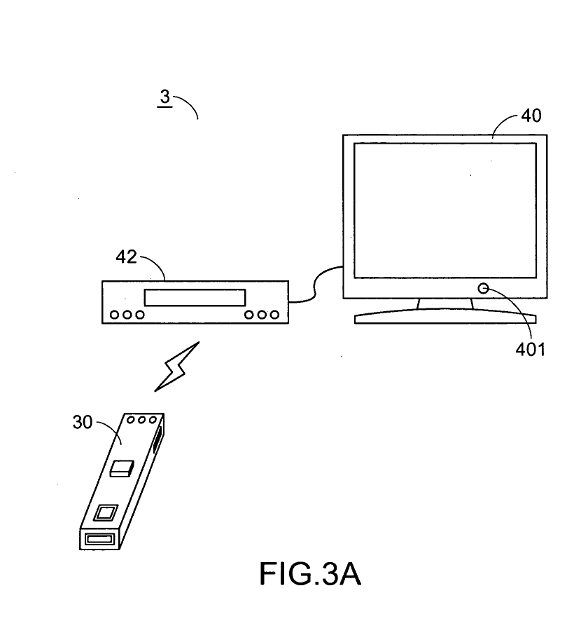

FIG. 3A is a schematic diagram illustrating a home entertainment system according to an embodiment of the present invention. The home entertainment system 3 is an audio/video system that integrates multiple audio/video devices and a remote controller. For clarification and brevity, only two audio/video devices are shown in the drawings. As shown in FIG. 3A, the home entertainment system 3 comprises a remote controller 30, a first audio/video device 40 (e.g. a TV set) and a second audio/video device 42 (e.g. a DVD recorder). The TV set 40 communicates with the DVD recorder 42. In addition, the TV set 40 has a wireless signal receiver 401 for receiving the wireless signals transmitted from the remote controller 30. According to the wireless signals, the TV set 40 is powered on or implements associated operations.

FIG. 3B is a schematic perspective view illustrating the outward appearance of the remote controller used in the home entertainment system of the present invention. The main body of the remote controller 30 has an active button 31. When the active button 31 is depressed, an activating signal is generated. At this moment, the user could operate the remote controller 30 to click a selective item and/or implement a function according to the user's motion. Moreover, the main body of the remote controller 30 has a fingerprint identification unit 32 for recognizing the identity of the user. In an embodiment, an electronic menu of the home entertainment system 3 is activated when the identity of the user is accurately recognized by the fingerprint identification unit 32. Please refer to FIG. 3B again. The remote controller 30 further comprises a light-emitting unit 33, a sound-emitting unit 34 and a force-generating unit 35. The light-emitting unit 33 could generate a light prompt. The sound-emitting unit 34 could generate a sound prompt. The force-generating unit 35 could generate a vibration or a force pulse. In an embodiment, the light-emitting unit 33 and the sound-emitting unit 34 are disposed on the external surface of the main body of the remote controller 30 in order to output the light prompt and the sound prompt. The operations of the home entertainment system 3 and the remote controller 30 will be illustrated in more details later.

FIG. 3C is a schematic functional block diagram illustrating the remote controller of FIG. 3B. In addition to the active button 31, the fingerprint identification unit 32, the light-emitting unit 33, the sound-emitting unit 34 and the force-generating unit 35, the remote controller 30 further comprises a motion-sensing unit 36, a microprocessor 37 and a wireless transmission unit 38. An example of the motion-sensing unit 36 includes but is not limited to an accelerometer, a gyroscope, an electronic compass, or a combination thereof. According to a motion of the remote controller 30 held by the user, the motion-sensing unit 36 generates a corresponding sensing signal. Since the sensing signal generated by the accelerometer or the gyroscope is in an analog format, the remote controller 30 further comprises a signal converter 361 for converting the analog sensing signal into a digital format. The digital sensing signal is then transmitted to the microprocessor 37. The digital sensing signal is processed by the microprocessor 37, thereby issuing a control signal. In some embodiments, the control signal is generated by the microprocessor 37 according to the sensing signal and the activating signal, thereby implementing associated tasks.

Please refer to FIG. 3C again. The active button 31, the fingerprint identification unit 32, the light-emitting unit 33, the sound-emitting unit 34, the force-generating unit 35 and the wireless transmission unit 38 are all in communication with the microprocessor 37. The fingerprint identification unit 32 is used for recognizing the identity of the user. In an embodiment, an electronic menu of the home entertainment system is activated after the recognizing result is realized by the microprocessor 37. The wireless transmission unit 38 is used for receiving and transmitting wireless signals. An example of the wireless transmission unit 38 includes but is not limited to a 27 MHz or 2.4 GHz radio frequency (RF) module, a Bluetooth transmission module or an IR transmission module. Alternatively, the light-emitting unit 33, the sound-emitting unit 34 and the force-generating unit 35 could generate or issue corresponding prompts according to the control signal.

The remote controller 30 is used for operating the audio/video devices of the home entertainment system 3. By operating the remote controller, an electronic menu or an on-screen display (abbreviated OSD) is shown on the screen of the TV set or other audio/video device. The audio/video device of the home entertainment system 3 could receive wireless signals. For example, the TV set 40 has a wireless signal receiver 401 for receiving the wireless signals transmitted from the remote controller 30.

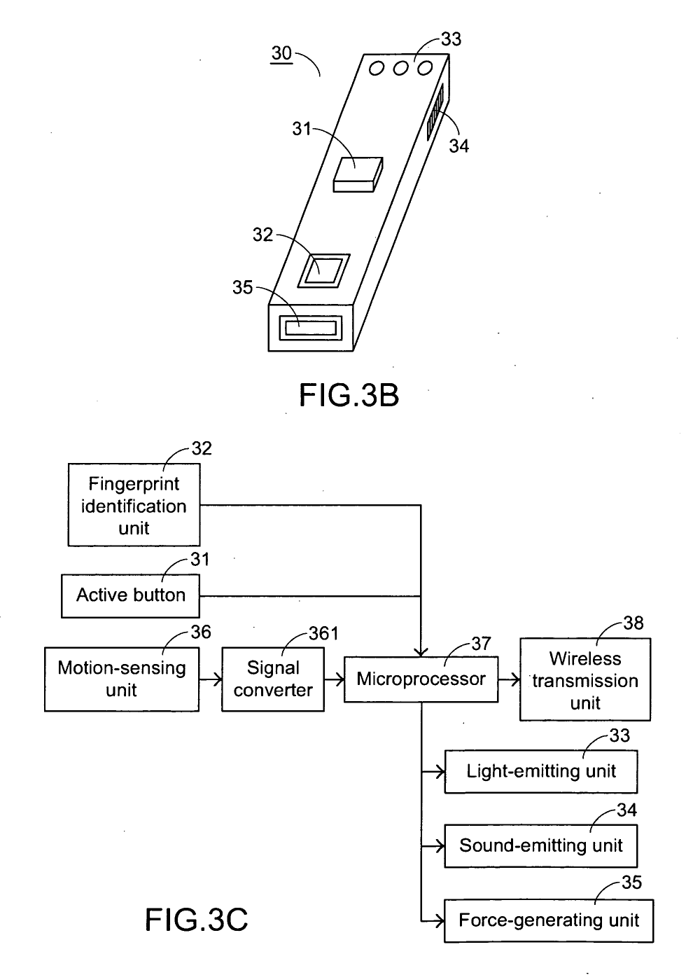

FIG. 4 is a schematic view illustrating an exemplary electronic menu shown on a screen of the TV set. For example, an electronic menu including multiple selective items I11˜I33 is shown on the screen of the TV set 40. There selective items I11˜I33 are illustrated as rectangular displaying blocks and arranged in an array. According to the practical requirement of the electronic menu, the areas of respective selective items I11˜I33 could be identical or different. In addition, depending on the types or numbers of audio/video devices included in the home entertainment system, the numbers of the selective items are varied.

For example, when the user's finger touches the fingerprint identification unit 32, the recognizing result is transmitted from the fingerprint identification unit 32 to the microprocessor 37. If the identity of the user is confirmed according to the recognizing result, the microprocessor 37 will issue the control signal to the wireless signal receiver 401 of the TV set 40. According to the control signal, the electronic menu including the selective items I11˜I33 is shown on the screen of the TV set 40. Meanwhile, by operating (e.g. moving or rotating) the remote controller 30, the user could move or choose a desired selective item from the electronic menu.

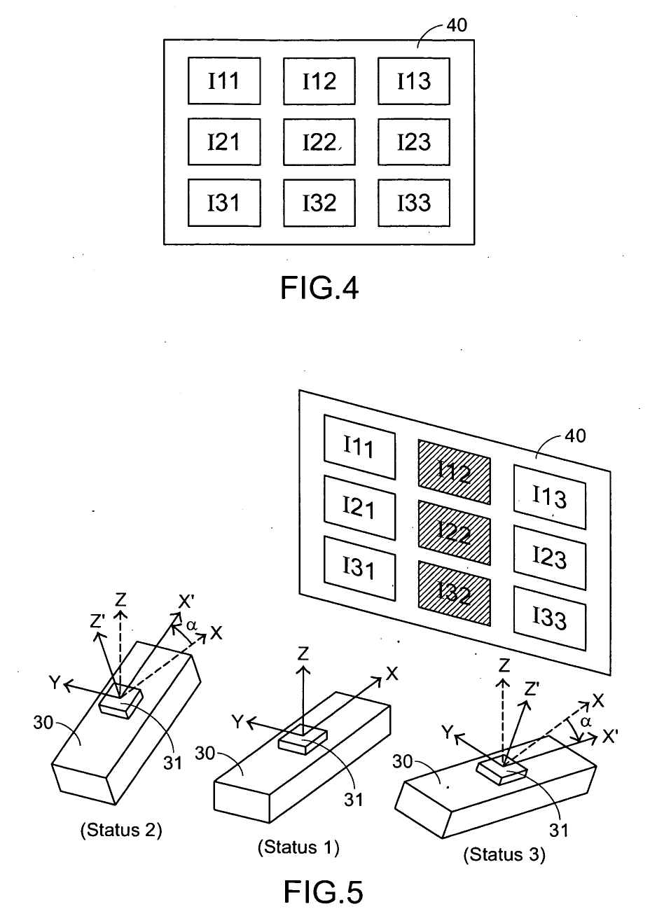

FIG. 5 is a schematic diagram illustrating the relationships between the pitch motions of the remote controller and the electronic menu. Depending on the user's gestures of holding the remote controller 30, the pitch motions of the remote controller 30 are changeable. In the status 1, the normal directions of three adjacent vertical faces of the remote controller 30 are parallel to the X-axis, Y-axis and Z-axis, respectively. At this moment, the selective item I22 shown on the screen of the TV set 40 is predetermined to be a highlighted selective item. The highlighted selective item is distinguished from other selective items in displaying color or contrast color. In the status 2, the remote controller 30 is upwardly rotated by an angle with respect to the Y-axis while continuously depressing the active button 31, so that the X-axis and the Z-axis are respectively adjusted to the X′-axis and the Z′-axis. According to the upwardly rotating motion of the remote controller 30, the motion-sensing unit 36 generates a corresponding sensing signal. In response to the sensing signal, the highlighted selective item is moved to the selective item I12. In the status 3, the remote controller 30 is downwardly rotated by an angle with respect to the Y-axis while continuously depressing the active button 31, so that the X-axis and the Z-axis are respectively adjusted to the X′-axis and the Z′-axis. According to the downwardly rotating motion of the remote controller 30, the motion-sensing unit 36 generates a corresponding sensing signal. In response to the sensing signal, the highlighted selective item is moved to the selective item I32.

In other words, when the main body of the remote controller 30 is moved or rotated by the user and the active button 31 is continuously depressed, a desired selective item could be highlighted, chosen or scanned. Moreover, the highlighted selective item is dependent on the elevation angle or depression angle of the remote controller 30. As shown in FIG. 5, since the remote controller 30 is rotated with respect to the Y-axis, the highlighted selective items are switched in the vertical direction of the electronic menu.

When the active button 31 is continuously depressed and the main body of the remote controller 30 is rotated by an elevation angle greater than a specified angle α, the highlighted selective item will be upwardly moved from the selective item I22 to I12 for example. Whereas, when the active button 31 is continuously depressed and the main body of the remote controller 30 is rotated by a depression angle greater than the specified angle α, the highlighted selective item will be downwardly moved from the selective item I22 to I32 for example. On the other hand, if the elevation angle or depression angle of rotating the remote controller 30 is smaller than the specified angle α, the highlighted selective item is not changed and maintained in the selective item I22. In some embodiments, when two successive downward pitch motions of the remote controller 30 are performed, the highlighted selective item could be switched from I12 to I32. In some embodiments, after a downward pitch motion of the remote controller 30 is performed, the remote controller 30 is slightly returned to the original position and then the next downward pitch motion of the remote controller 30 will be done. Alternatively, after the highlighted selective item is switched from I12 to I22 (status 1), the next downward pitch motion of the remote controller 30 will be done (status 3) in order to switch the highlighted selective item from I22 to I23.

In some embodiments, after one of the selective items is highlighted, the highlighted selective item is locked if the active button 31 is no longer depressed. For example, after the selective item I12 is highlighted and the active button 31 is no longer depressed, the selective item I12 is locked and will not be influenced by the motion of the remote controller 30. At this moment, the user could continuously depress the active button 31 for two times in a short time interval, so that the function associated with the locked selective item will be performed on the TV set 40 or other audio/video device according to the control signal issued by the microprocessor 37.

In some embodiments, when the active button 31 is continuously depressed and the main body of the remote controller 30 is moved, the light-emitting unit 33 and/or the sound-emitting unit 34 could generate a light prompt and/or a sound prompt to notify the user. For example, when a selective item is highlighted, a clicking sound prompt is emitted by the sound-emitting unit 34. Alternatively, when the highlighted selective item is switched from one to another, another sound prompt and a light prompt are simultaneously emitted to notify the user. Moreover, when the one of the selective items is highlighted and locked if the active button 31 is no longer depressed, a confirmation sound prompt and confirmation light prompt are simultaneously emitted to notify the user. In other words, the sound prompts or light prompts are variable according to the operating statuses of the remote controller 30.

In some embodiments, when the active button 31 is continuously depressed for two times in a short time interval, an activating signal is transmitted from the active button 31 to the microprocessor 37. After the activating signal is received by the microprocessor 37, a corresponding control signal is wirelessly transmitted from the microprocessor 37 to the TV set 40 through the wireless transmission unit 38. According to the control signal, the function associated with the locked selective item will be implemented.

In some embodiments, when the active button 31 is continuously depressed for more than two times in a short time interval, the activating signal is generated. Moreover, in addition to the light prompt or the sound prompt, the remote controller 30 also generates a vibration or a force pulse when the associated function is implemented.

The functions correlating with the selective items include the possible functions that are executable in the applied audio/video device such as a game device, an audio/video device, a sound device, a signal displaying or recording device, or a network device. For example, if the functions correlate to channel or volume adjustment, the selective items could be designed as a digital key keyboard or a directional key keyboard. In some embodiments, after a main-menu is created, some sub-menus in a hierarchical arrangement are successively created. That is, the electronic menu could be a hierarchical menu.

In the embodiment of FIG. 3A, the operating method of the present invention is illustrated by referring to the TV set 40. Nevertheless, the remote controller 30 could be used to operate all audio/video devices of the home entertainment system 3. For example, as shown in FIG. 3, the remote controller 30 could be also used to control operations of the DVD recorder 42. It is of course that the wireless signal receiver could be arranged on the TV set 40 or the DVD recorder 42. Via the electronic menu shown on the TV set 40, the operations of the DVD recorder 42 will be controlled by the remote controller 30. Under this circumstance, the selective items of the hierarchical menu include the functions of the DVD recorder 42.

Moreover, various signals such as satellite signals, wired signals, wireless radio signals or network signals could be applied to the home entertainment system 3. In some embodiments, the functions of the selective items include the functions of adjusting the resolution according to the digital TV specifications. In some embodiments, the functions of the selective items include the functions of enriching the sound reproduction quality (e.g. the Hi-Fi Stereo, Dolby 5.1 or Dolby 7.1 multi-channel surround sound effects). In some embodiments, the functions of the selective items include the functions of accessing or storing data files into associated storage devices, or exchanging data between different audio/video devices.

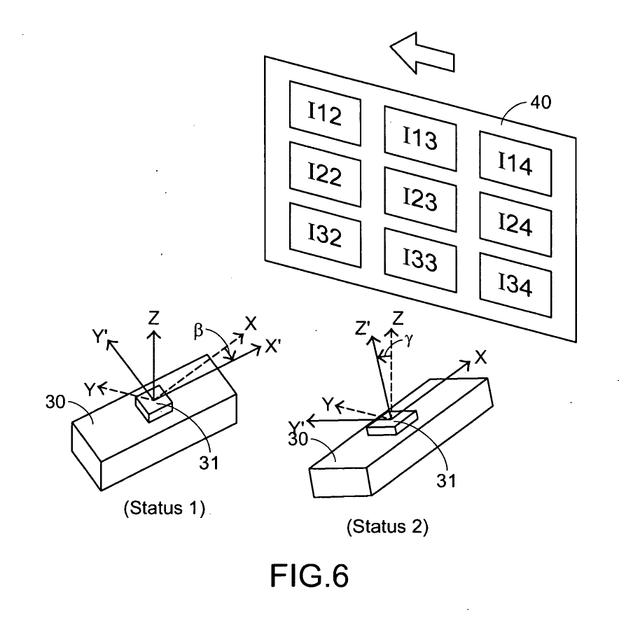

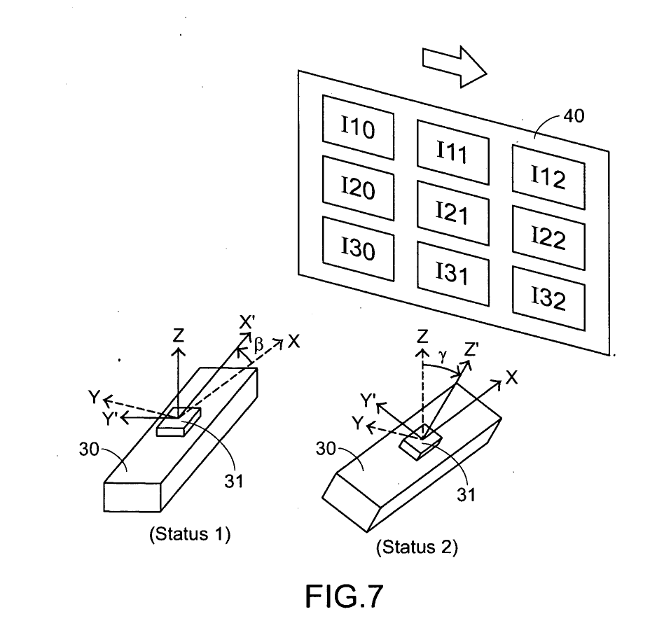

FIG. 6 is a schematic diagram illustrating one-column right-side movement of the electronic menu according to the right yaw motion and the left rolling motion of the remote controller. FIG. 7 is a schematic diagram illustrating one-column right-side according to the left yaw motion and the right rolling motion of the remote controller.

According to the right yaw motion or left yaw motion, more selective items will be switched or shown. When one of the selective items at the left side of the electronic menu is highlighted (see FIG. 5), the remote controller 30 is tilted toward the right side by an angle β with respect to the Z-axis (i.e. a right yaw motion). As such, the X-axis and the Y-axis are respectively adjusted to the X′-axis and the Y′-axis (see the status 1 in FIG. 6). According to the right yaw motion of the remote controller 30, the motion-sensing unit 36 generates a corresponding sensing signal. In response to the sensing signal, the selective items at the left side of the electronic menu are all switched. Similarly, when one of the selective items at the right side of the electronic menu is highlighted (see FIG. 5), the remote controller 30 is tilted toward the left side by an angle β with respect to the Z-axis (i.e. a left yaw motion). As such, the X-axis and the Y-axis are respectively adjusted to the X′-axis and the Y′-axis (see the status 1 in FIG. 7). According to the left yaw motion of the remote controller 30, the motion-sensing unit 36 generates a corresponding sensing signal. In response to the sensing signal, the selective items at the right side of the electronic menu are all switched.

That is, the selective items are moved in a column according to the right yaw motion or the left yaw motion of the remote controller 30. For example, when the selective item I13, I23 or I33 is highlighted (see FIG. 4), the selective items I11, I12 and I31 will be disappeared but the selective items I14, I24 and I34 will be shown on the electronic menu 40 according to the right yaw motion of the remote controller 30 (see FIG. 6). That is, the right yaw motion of the remote controller 30 corresponds to one-column left-side movement of the electronic menu 40, so that the new selective items I12˜I34 are shown on electronic menu 40. In addition, when the selective item I13, I23 or I33 is highlighted (see FIG. 4), the selective items I13, I23 and I33 will be disappeared but the selective items I10, I20 and I30 will be shown on the electronic menu 40 according to the left yaw motion of the remote controller 30 (see FIG. 7). That is, the right yaw motion of the remote controller 30 corresponds to one-column right-side movement of the electronic menu 40, so that the new selective items I10˜I32 are shown on electronic menu 40.

Similarly, according to the left rolling motion or the right rolling motion, more selective items will be switched or shown. By rolling the remote controller 30 in the left side by an angle γ with respect to the Y-axis and Z-axis (i.e. a left rolling motion), the Y-axis and the Z-axis are respectively adjusted to the Y′-axis and the Z′-axis (see the status 2 in FIG. 6). According to the left rolling motion of the remote controller 30, the motion-sensing unit 36 generates a corresponding sensing signal. In response to the sensing signal, the new selective items I12˜I34 are shown on electronic menu 40. Similarly, by rolling the remote controller 30 in the right side by an angle γ with respect to the Y-axis and Z-axis (i.e. a right rolling motion), the Y-axis and the Z-axis are respectively adjusted to the Y′-axis and the Z′-axis (see the status 2 in FIG. 7). According to the right rolling motion of the remote controller 30, the motion-sensing unit 36 generates a corresponding sensing signal. In response to the sensing signal, the new selective items I10˜I32 are shown on electronic menu 40. Like the operations of FIG. 5, the active button 31 is continuously depressed during the yaw motion or the rolling motion is done. After the active button 31 is no longer depressed, the selective items will not be switched. Meanwhile, the functions as described in FIG. 5 could be implemented as required.

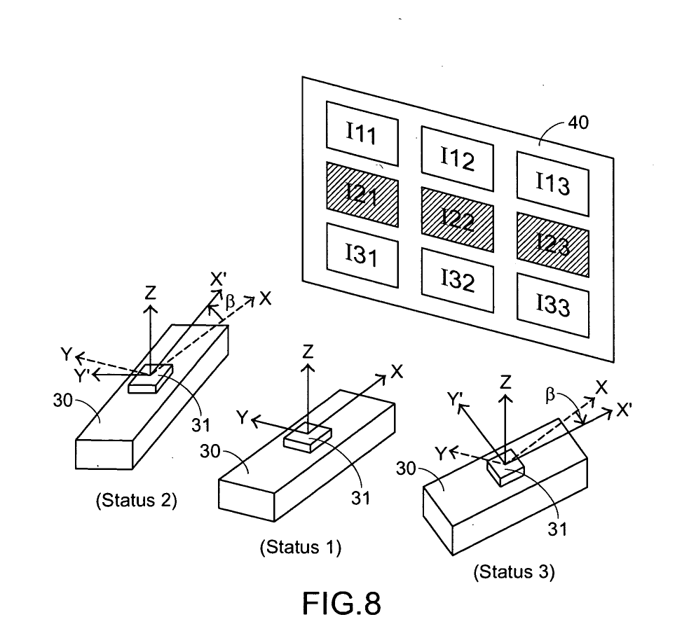

FIG. 8 is a schematic diagram illustrating the relationships between the yaw motions of the remote controller and the electronic menu. When the active button 31 is continuously depressed and the main body of the remote controller 30 is tilted toward the left side by an angle greater than the specified angle β with respect to the Z-axis (i.e. a left yaw motion), the highlighted selective item will be moved from the selective item I22 to I21 (i.e. from the status 1 to the status 2 in FIG. 8). Whereas, when the active button 31 is continuously depressed and the main body of the remote controller 30 is tilted toward the right side by an angle greater than the specified angle β with respect to the Z-axis (i.e. a right yaw motion), the highlighted selective item will be moved from the selective item I22 to I23 (i.e. from the status 1 to the status 3 in FIG. 8). On the other hand, if the remote controller 30 is tilted toward the left or right side by an angle smaller than the specified angle β, the highlighted selective item is not changed and maintained in the selective item 122.

Similarly, the selective items could be moved in a row in the vertical direction according to the pitch motion of the remote controller 30. For example, when the main body of the remote controller 30 is rotated by an elevation angle or a depression angle greater than a specified angle (α+δ), the selective items shown on the electronic menu 40 are moved in a row in the vertical direction.

In some embodiments, all selectively items on the electronic menu 40 are replaced by new ones according to the rolling motion of the remote controller 30. For example, according to the rolling motion of the remote controller 30, the selectively items in a 3×3 matrix arrangement are all replaced with other selectively items in a 3×3 matrix arrangement. That is, the new selective items I14˜I36 (not shown) will be shown on electronic menu 40 in order to facilitate quickly finding the desired selective item.

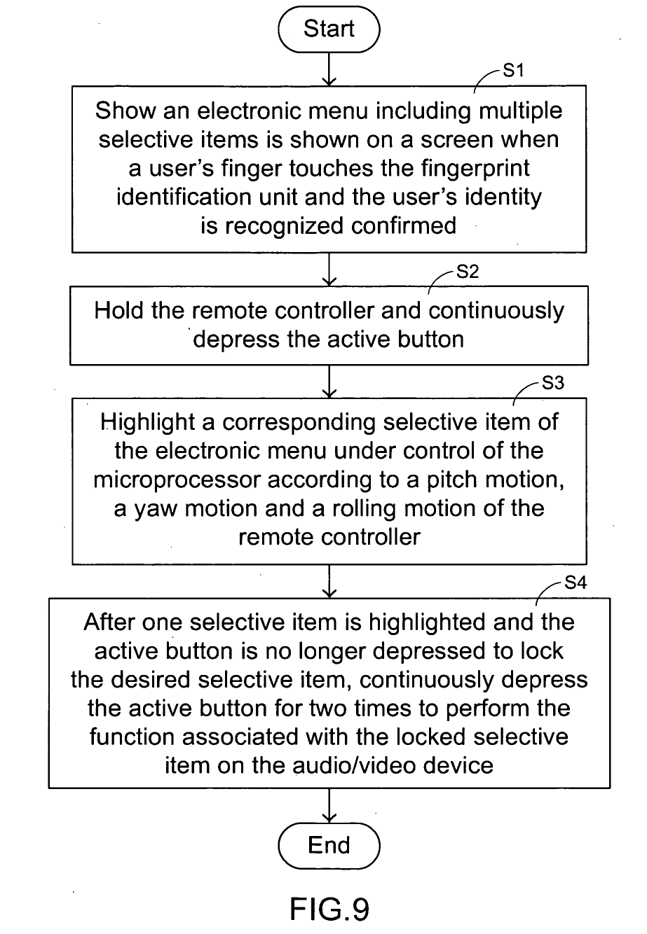

FIG. 9 is a flowchart schematically illustrating a method for operating the home entertainment system according to an embodiment of the present invention. First of all, an electronic menu including multiple selective items is shown on a screen when a user's finger touches the fingerprint identification unit and the user's identity is recognized confirmed (Step S1). Next, the remote controller is held by the user while the active button is continuously depressed (Step S2). According to a pitch motion, a yaw motion and a rolling motion of the remote controller, a corresponding selective item of the electronic menu is highlighted under control of the microprocessor (Step S3). After one selective item is highlighted and the active button is no longer depressed to lock the desired selective item, the active button is continuously depressed for two times so as to perform the function associated with the locked selective item on the audio/video device (Step S4).

In the above embodiments, the electronic menu is shown when the user's finger touches the fingerprint identification unit 32. Alternatively, the fingerprint identification unit could be exempted from the remote controller 30. When the main body of the remote controller 30 is held by the user and the active button 31 of the remote controller 30 is quickly depressed and then released, the electronic menu is shown on the screen in response to the activating signal under control of the microprocessor 37.

In some embodiment, the remote controller could cooperate with the electronic menu to implement a tutorial function or a custom-made function. For example, according to the user's settings, a specified function is implemented and a specified prompt signal is generated in response to a specified motion of the main body of the remote controller. The specified function is set in a specified selective item of the electronic menu. Once the specified motion of the main body is performed, a control signal is generated to activate the specified function. In addition, the specified prompt signal is generated to notify the user that it is necessary to depress the active button 31 to active the specified function.

In some embodiments, if some functions are frequently used, these functions are implemented according to corresponding motions of the remote controller without the cooperation of the electronic menu. For example, even if no electronic menu is shown, the sound volume could be increased or decreased when the main body of the remote controller 30 is subject to a right yaw motion or a left yaw motion and the active button 31 is continuously depressed. In addition, the channel number could be increased or decreased when the main body of the remote controller 30 is subject to an upward pitch motion or a downward pitch motion and the active button 31 is continuously depressed. Alternatively, the TV set 40 could be powered on or power off when the main body of the remote controller 30 is subject to an upward pitch motion or a downward pitch motion and the active button 31 is continuously depressed. In some embodiments, even if no electronic menu is shown, a specified function is implemented according to the hand's gesture. For example, the user could move the remote controller to write a specified number. After the active button 31 is depressed or a preset time interval has elapsed, the channel number corresponding to the number written according to the hand's gesture will be chosen.

From the above description, the remote controller of the present invention has less operating keys or buttons in comparison with the conventional remote controller. According to the motion of the remote controller, the selective item of an electronic menu shown on the screen of the audio/video signal is highlighted, so that the function corresponding to the highlighted selective item will be implemented. Since the user needs not to continuously look at the remote controller during the process of operating the remote controller, the desired function could be quickly implemented and the possibility of causing erroneous operations will be minimized. Moreover, the enjoyment and the efficacy of operating the home entertainment system will be enhanced. In other words, by using the operating method of the present invention, all of the audio/video devices included in the home entertainment system could be easily operated.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A home entertainment system comprising:
a first audio/video device having a wireless signal receiver; and
a remote controller comprising:
a main body held by a user;
a motion-sensing unit disposed within the main body for generating a sensing signal in response to a motion of the main body by the user;
a microprocessor disposed within the main body and communicating with the motion-sensing unit for processing the sensing signal, thereby generating a control signal; and
a wireless transmission unit communicating with the microprocessor for receiving the control signal and wirelessly transmitting the control signal to the wireless signal receiver, wherein a first selective item of an electronic menu shown on the first audio/video device is highlighted according to the control signal.

2. The home entertainment system according to claim 1 wherein the remote controller further comprises a fingerprint identification unit, which is disposed within the main body and communicates with the microprocessor for recognizing an identity of the user, wherein the electronic menu is shown on the first audio/video device under control of the microprocessor if the recognizing result confirms the identity of the user.

3. The home entertainment system according to claim 1 wherein the remote controller further comprises:
a light-emitting unit, which is disposed within the main body and communicates with the microprocessor for generating a light prompt according to the control signal;
a sound-emitting unit, which is disposed within the main body and communicates with the microprocessor for generating a sound prompt according to the control signal; and
a force-generating unit, which is disposed within the main body and communicates with the microprocessor for generating a vibration or a force pulse according to the control signal.

4. The home entertainment system according to claim 1 wherein the motion of the main body includes a pitch motion, a yaw motion or a rolling motion.

5. The home entertainment system according to claim 1 wherein the remote controller further comprises an active button, which is disposed on the main body and communicates with the microprocessor, wherein an activating signal is generated by the remote controller when the active button is depressed, and the microprocessor issues the control signal in response to the sensing signal and the activating signal.

6. The home entertainment system according to claim 5 wherein the active button is continuously depressed during the motion of the main body is done.

7. The home entertainment system according to claim 5 wherein the first selective item is locked after the first selective item is highlighted and the active button is released, and a function corresponding to the locked first selective item is implemented in the first audio/video device after the active button is depressed again.

8. The home entertainment system according to claim 1 wherein the motion-sensing unit includes an accelerometer, a gyroscope, an electronic compass, or a combination thereof.

9. The home entertainment system according to claim 1 wherein the first audio/video device includes a screen and the electronic menu is shown on the screen.

10. The home entertainment system according to claim 1 wherein the electronic menu includes multiple selective items including the first selective item, and the highlight effect is moved from a second selective item to the first selective item.

11. The home entertainment system according to claim 10 further comprising a second audio/video device communicating with the first audio/video device, wherein the electronic menu shown on the first audio/video device includes one or more selective items corresponding to functions executable in the second audio/video device.

12. An operating method of a home entertainment system, the home entertainment system comprising a first audio/video device and a remote controller, the operating method comprising steps of:
showing an electronic menu on the first audio/video device;
holding a main body of the remote controller and creating a motion of the main body, so that a first selective item of the electronic menu is highlighted in response to the motion of the main body; and
allowing the first audio/video device to implement a function corresponding to the first selective item.

13. The operating method according to claim 12 wherein the electronic menu includes multiple selective items including the first selective item, and the operating method includes a step of performing a pitch motion of the main body, so that the highlight effect is moved from a second selective item to the first selective item in a vertical direction.

14. The operating method according to claim 12 wherein the electronic menu includes multiple selective items including the first selective item, and the operating method includes a step of performing a yaw motion of the main body, so that the highlight effect is moved from a second selective item to the first selective item in a horizontal direction.

15. The operating method according to claim 12 wherein the electronic menu includes multiple selective items including the first selective item, and the operating method includes a step of performing a rolling motion of the main body, so that the selective items are switched in a column.

16. The operating method according to claim 12 wherein the remote further comprises a fingerprint identification unit, the operating method further includes a step of recognizing an identity of the user when the fingerprint identification unit is touched by the user's finger, and showing the electronic menu on the first audio/video device if the recognizing result confirms the identity of the user.

17. The operating method according to claim 12 wherein the remote controller further includes an active button, and the active button is continuously depressed during the motion of the main body is done.

18. The operating method according to claim 17 wherein the first selective item is locked after the first selective item is highlighted and the active button is released, and a function corresponding to the locked first selective item is implemented in the first audio/video device after the active button is depressed again.

19. The operating method according to claim 17 wherein the electronic menu is shown on the first audio/video device after the active button is pressed for one time and then released.

20. The operating method according to claim 12 wherein the home entertainment system further includes a second audio/video device communicating with the first audio/video device, and the electronic menu shown on the first audio/video device includes one or more selective items corresponding to functions executable in the second audio/video device.
